(19) United States
(12) Patent Application Publication
(10) Pub. No.: US 2026/0167241 A1
(43) Pub. Date: Jun. 18, 2026

(54) MULTI-USE WAGON

(71) Applicant: Eitan Kramer, Los Angeles, CA (US)

(72) Inventor: Eitan Kramer, Los Angeles, CA (US)

(21) Appl. No.: 19/399,775

(22) Filed: Nov. 25, 2025

Related U.S. Application Data
(60) Provisional application No. 63/724,842, filed on Nov. 25, 2024.

(51) Int. Cl. B62B 3/02

(52) U.S. Cl. CPC B62B 3/02; B62B 2205/24; B62B 2301/04

(57) ABSTRACT

A multi-use wagon is presented that can be reconfigurably adapted for different functions, uses, terrains and/or environments, and adapted for safe carriage of a wide variety and shape of loads such as children, boxes, goods and other items. The multi-use wagon includes a chassis formed of a number of interconnected tubes that include a proximal raised cross bar connected with a proximal base section, and a distal raised cross bar connected with a distal base section, the proximal base section and distal base section being connected together to form a unitary, substantially horizontal chassis base, and connected together by a hinge that allows the proximal base section and distal base section to fold against each other. The wagon further includes at least three wheels connected with the chassis, at least two of the at least three wheels being connected to the proximal base section by an axle.

### CROSS REFERENCE TO RELATED APPLICATIONS

This application claims the benefit of U.S. Provisional Application No. 63/724,842, filed Nov. 25, 2024. This application is incorporated herein by reference in its entirety.

### BACKGROUND

A wagon is a well-known piece of utilitarian equipment. A typical or conventional wagon includes a carriage or bed, and four wheels attached to the carriage to allow it to be moved. Many conventional wagons can include a handle as well, for allowing a user to pull or push the wagon. A wagon can be used to carry things, including goods and people such as kids. However, conventional wagons are limited in their utility, i.e., they are neither configurable nor reconfigurable for a variety of different functions or uses, including many different terrains and/or environments. What is needed is a multi-use wagon that can be configured and reconfigured to adapt to many different functions, uses, terrains and environments.

### SUMMARY

This document presents a multi-use wagon that can be reconfigurably adapted for many different functions, uses, terrains and/or environments, and which is adapted for safe carriage of a wide variety and shape of loads such as children, boxes, goods and other items.

In some aspects, a multi-use wagon configured to be pulled or pushed by a user. The multi-use wagon includes a chassis formed of a number of interconnected tubes that include a proximal raised cross bar connected with a proximal base section, and a distal raised cross bar connected with a distal base section, the proximal base section and distal base section being connected together to form a unitary, substantially horizontal chassis base, and connected together by a hinge that allows the proximal base section and distal base section to fold against each other. The wagon further includes at least three wheels connected with the chassis, at least two of the at least three wheels being connected to the proximal base section by an axle.

In some aspects, the proximal base section and distal base section fold upwardly, to allow the chassis base to fold and collapse together. In yet other aspects, the proximal raised cross bar includes opposing vertical members connected to the proximal base section of the chassis base on a lower end and by a first cross horizontal member above the chassis base on an upper end.

In yet other aspects, each of the proximal raised cross bar and distal raised cross bar is connected by a hinge to the respective proximal base section and distal base section. The hinge is lockable to keep each raised cross bar in an upright position, and unlockable to allow each raised cross bar to be folded against the respective base section.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 shows a multi-use wagon including a chassis, four wheels connected with the chassis, and a handle;

FIG. 2 illustrates a folding process for folding and collapsing the chassis to a much smaller form factor;

FIG. 3 illustrates a universal hinge for a wagon as described herein, particularly for use to connect together the proximal base section and the distal base section of the chassis base;

FIG. 4 illustrates an implementation of a carriage of the wagon that includes a bucket the form of a collapsible and soft material and structure;

FIG. 5 shows a multi-use wagon system with one or more hard buckets;

FIG. 6 illustrates a number of accessories that can be integrated with the multi-use wagon described herein; and

Appendix A illustrates various features, aspects, and embodiments of a multi-use wagon, in accordance with preferred implementations and as described herein.

Like reference symbols in the various drawings indicate like elements.

### DETAILED DESCRIPTION

This document describes a multi-use wagon. The multi-use wagon provides highly customizable options for both the utility and stroller wagon segments. Additionally, the multi-use wagon presents opportunities in the light transport and delivery sectors, including services such as online shopping service, mail services.

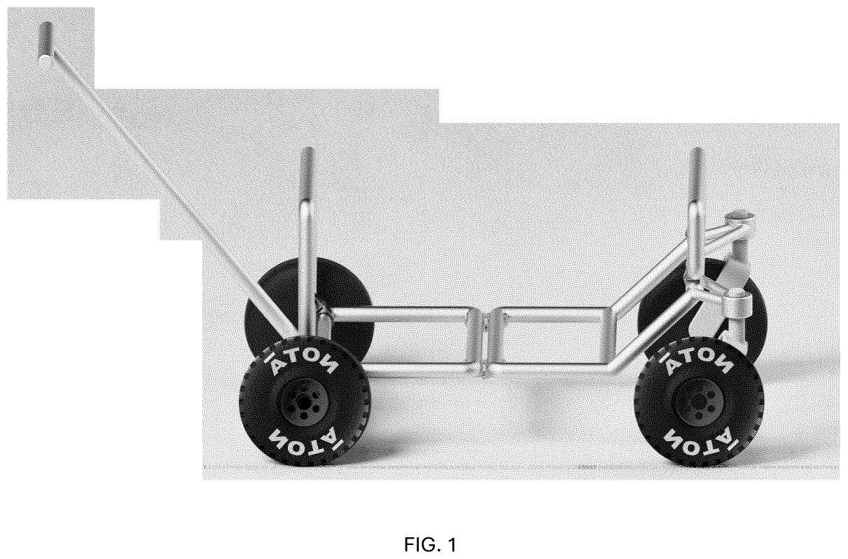

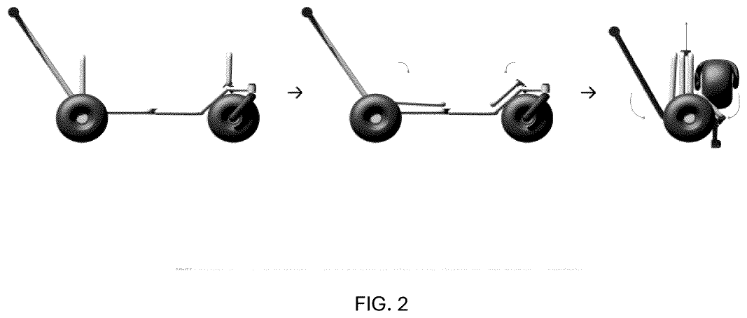

In some implementations, the multi-use wagon is a vehicle that includes a chassis and four wheels connected with the chassis. The chassis includes a number of interconnected tubes as shown in FIG. 1. The interconnected tubes that form the chassis include a proximal raised cross bar connected with a proximal base section, and a distal raised cross bar connected with a distal base section. The proximal base section and distal base section are connected together to form a unitary, substantially horizontal chassis base, and can be connected together by a hinge, described in further detail below, and which allows the proximal base section and distal base section to fold against each other, preferably upwardly, to allow the chassis base to fold and collapse together.

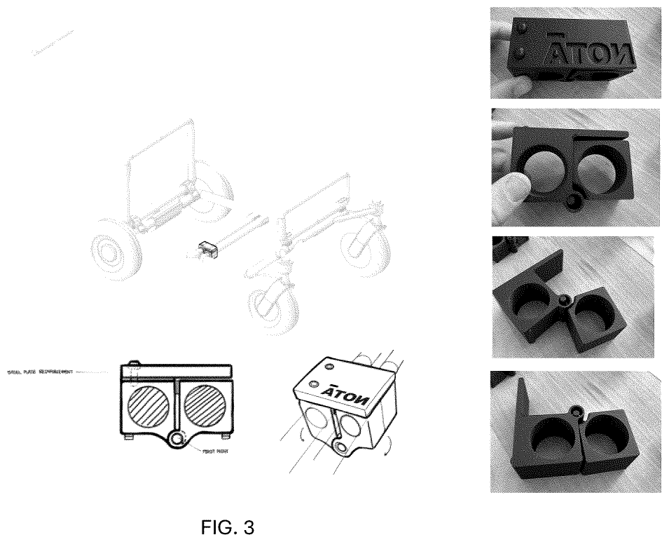

The proximal raised cross bar can include opposing vertical members connected to the proximal base section of the chassis base on a lower end and by a first cross horizontal member above the chassis base on an upper end. The distal raised cross bar can also include opposing vertical members connected to the distal base section of the chassis base on a lower end and by a second cross horizontal member above the chassis base on an upper end. Each of the proximal raised cross bar and distal raised cross bar can be connected by a hinge to the respective proximal base section and distal base section. The hinge can be lockable to keep each raised cross bar in an upright position, and unlockable to allow each raised cross bar to be folded against the respective base section, as shown in more detail in FIG. 2.

The four wheels can be connected with the chassis in various ways. In some implementations, at least two stationary wheels, such as two proximal wheels, are connected to the proximal base section by an axle. The two stationary wheels can also be connected with the distal base section. In some implementations, at least two turnable wheels, such as two distal wheels are connected to the distal base section by casters that can swivel and turn the wheels based on operator force. For instance, the chassis can include an operator handle that extends from the chassis to enable an operator to direct the motion and direction of the wagon.

In some implementations, the handle includes an extending member that is connected to an extends from the chassis, such as the proximal base section. The handle can include a cross bar configured to be gripped by one or more hands of the operator. The extending member can be solid and unitary tube stem, or can be a telescoping member to extend or retract the handle to any desired position or length.

The chassis and handle can be made of any rigid or semi-rigid material, including, but not limited to, aluminum, stainless steel, carbon fiber, plastic, wood, bamboo or other organic material, or the like. The wheels can be solid or hollow, or can include an innertube. The wheels preferably include treading that allows gripping of a surface over which they roll, such as pavement, sand, grass, carpet, or the like.

FIG. 2 illustrates a folding process for folding and collapsing the chassis to a much smaller form factor. This feature allows the multi-use wagon to be easily transportable in the folded mode, both by being carried and by being stored. In some implementations, the folding process is as follows: the proximal (front) raised bar and the distal (rear) raised bar are folded down and inward toward each other, i.e., toward the center of the chassis. One or more of the vertical members of each of the proximal raised cross bar and the distal raised cross bar can include a latch or other locking mechanism to lock each raised bar in an upright position, and which can allow the folding down onto the base of the chassis by each raised cross bar, as shown in FIG. 2. Next the base is pulled up from the center, i.e., the proximal base section and the distal base section to allow the wheels to collapse together into a compact, easy-carry form.

In some implementations, as shown in FIG. 2, the proximal (front) wheels, which are preferably connected by casters to be able to be turned, can be removed and nested into designated spaces. In alternative implementations, the distal (rear) wheels can be connected by casters to allow the rear wheels to be able to be turned, and removed and stored as above. In yet other implementations, all four wheels are connected by casters, by a steering column, by an axle, or the like. In still yet other implementations, the front or rear wheels can be a single wheel that is able to be turned or is in a fixed position. The wheels need not be all the same size, depending on the use or application of the wagon.

Finally, in the folding process as illustrated in FIG. 2, the handle and T-bar can be collapsed for the most compact stowage, or kept elongated to allow a user to pull or move the collapsed chassis using only two wheels, for instance.

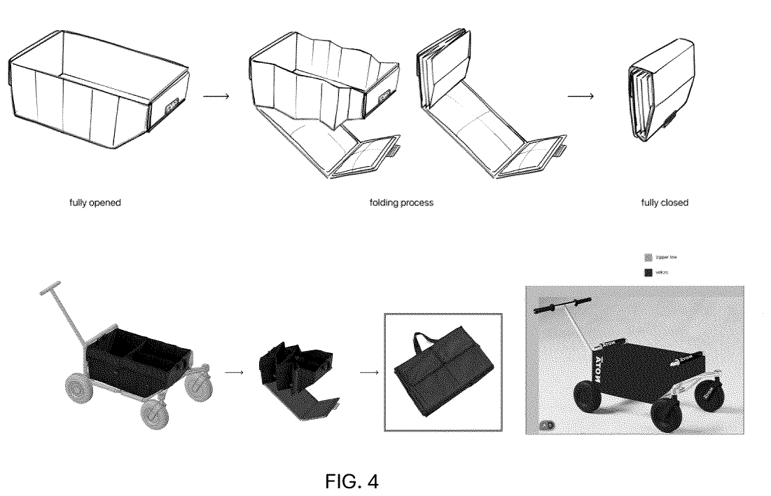

FIG. 3 illustrates a universal hinge for a wagon as described herein, particularly for use to connect together the proximal base section and the distal base section of the chassis base. As shown in FIG. 3, the hinge can be easily installed on the base with only one tool, and in some implementations no tools. The hinge allows the proximal base section and the distal base section of the chassis base to connect together, and provide a sturdy horizontal chassis base when connected and oriented horizontally, while allowing the proximal base section and the distal base section of the chassis base to be folded upward to collapse the chassis base as described above and illustrated in FIG. 2. The universal hinge can be made of high-grade, rigid molded plastic or nylon, or even a metal such as aluminum. Only one hinge need be used, although for added strength two or more hinges can be used. A variant of the universal hinge shown in FIG. 3 can be used to connect the vertical members of the proximal (front) raised bar and the distal (rear) raised bar.

FIG. 4 illustrates an implementation of a carriage of the wagon that includes a bucket the form of a collapsible and soft material and structure. The bucket can include a frame that is covered by soft but resilient material, such as nylon cloth, neoprene foam (which can be bounded on one or both sides with a jersey knit material, or other similar fabric. The bucket can be collapsible as well, to fold into a carrying case as shown in FIG. 4. The bucket allows for customization of the wagon, where the wagon can be anchored to the chassis and allow for additional, modular pieces to be placed in the bucket as described further below.

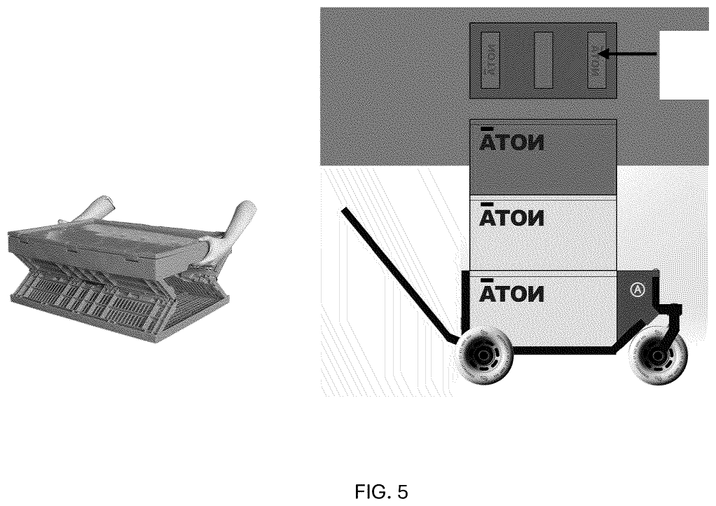

In some implementations, a multi-use wagon system can include one or more hard buckets, as shown in FIG. 5. Each hard bucket is also collapsible for easy storage, yet rigidly expandable for heavy duty storage of heavier items or more sensitive items. The hard buckets are formed with grooves, pegs, holes, tabs, ridges, or the like, so that they can be stacked on top of one another safely and securely, as shown in FIG. 5.

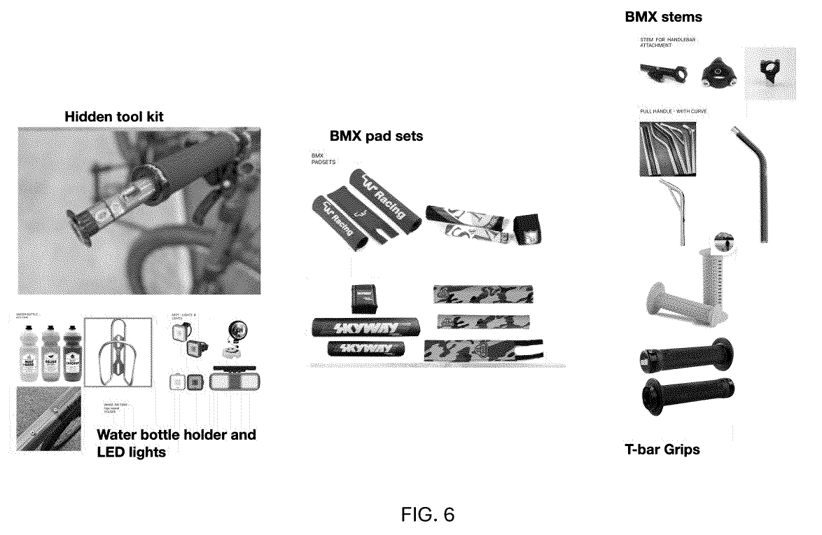

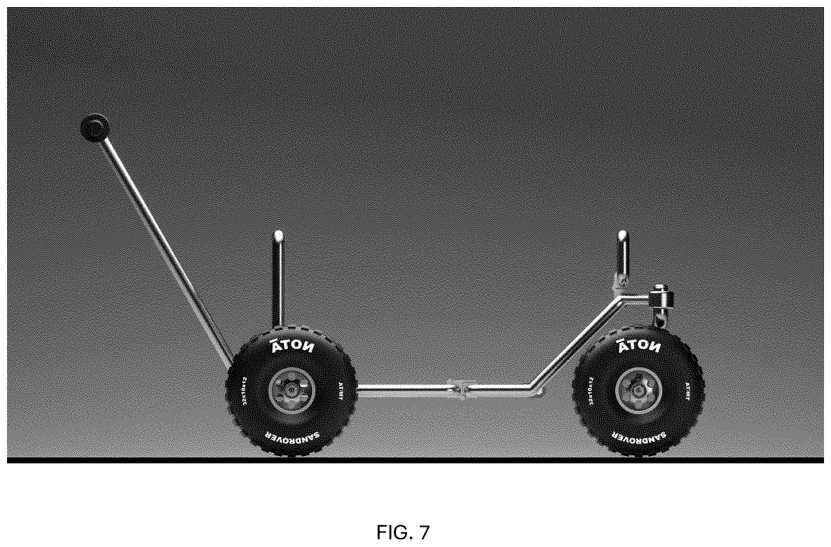

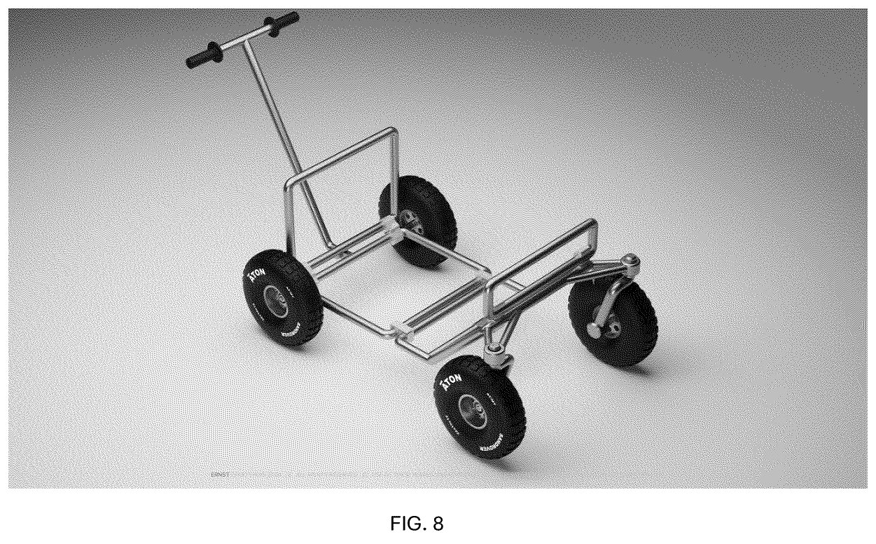

FIG. 6 illustrates a number of accessories that can be integrated with the multi-use wagon described herein. Such accessories can include, without limitation, a tool kit integrated with or hidden in a tube of the chassis or handle, padding, one or more bottle holders (which can be powered to keep the bottle contents warm or cold), hand grips, and customizable handle stems.

Appendix A illustrates various aspects of a multi-use wagon, in accordance with preferred implementations and as described herein.

Although a few embodiments have been described in detail above, other modifications are possible. Other embodiments may be within the scope of the following claims.

1. A multi-use wagon configured to be pulled or pushed by a user, the multi-use wagon comprising:
a chassis formed of a number of interconnected tubes that include a proximal raised cross bar connected with a proximal base section, and a distal raised cross bar connected with a distal base section, the proximal base section and distal base section being connected together to form a unitary, substantially horizontal chassis base, and connected together by a hinge that allows the proximal base section and distal base section to fold against each other; and
at least three wheels connected with the chassis, at least two of the at least three wheels being connected to the proximal base section by an axle.

2. The multi-use wagon in accordance with claim 1, wherein the proximal base section and distal base section fold upwardly, to allow the chassis base to fold and collapse together.

3. The multi-use wagon in accordance with claim 1, wherein the proximal raised cross bar includes opposing vertical members connected to the proximal base section of the chassis base on a lower end and by a first cross horizontal member above the chassis base on an upper end.

4. The multi-use wagon in accordance with claim 1, wherein at least one of the at least three wheels is connected to the distal base section by a caster that can swivel and turn the wheel based on operator force.

5. The multi-use wagon in accordance with claim 4, wherein at least two of the at least three wheels are each independently connected to the distal base section by a caster that can swivel.

6. The multi-use wagon in accordance with claim 3, wherein each of the proximal raised cross bar and distal raised cross bar is connected by a hinge to the respective proximal base section and distal base section.

7. The multi-use wagon in accordance with claim 6, wherein the hinge is lockable to keep each raised cross bar in an upright position, and unlockable to allow each raised cross bar to be folded against the respective base section.
